(19) United States
(12) Patent Application Publication
(10) Pub. No.: US 2005/0184040 A1
(43) Pub. Date: Aug. 25, 2005

(54) TIG welding method and welded structure made by the same

(75) Inventors: Tetsuji Yamamoto, Okazaki-shi (JP); Hirofumi Kuwabara, Kariya-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TOYODA KOKI KABUSHIKI KAISHA, Kariya-shi (JP)

(21) Appl. No.: 11/057,210

(22) Filed: Feb. 15, 2005

(30) Foreign Application Priority Data
Feb. 20, 2004 (JP) 2004-043938

(51) Int. Cl. B23K 9/23

(52) U.S. Cl. 219/137 WM

(57) ABSTRACT

A TIG welding torch 70 is set more adjacent to a first bus bar 30 than a second bus bar 40 to generate an arc. Consequently, the second bus bar 40 serving as a low melting point member is prevented from being over heated, occurrence of blow holes is suppressed, and inadequate melting of the first bus bar 30 serving as a high melting point member is improved, resulting in enhancement of welding strength. The method is applicable to electrical equipment, especially to a motor, provided to a vehicle.

### INCORPORATION BY REFERENCE

This application is based on and claims priority under 35 U.S.C. §119 to Japanese Patent Application No. 2004-043938 filed on Feb. 20, 2004. The contents of that application are incorporated herein by reference.

### BACKGROUND OF THE INVENTION

1. Field of the Invention

The present invention relates to a TIG (Tungsten Inert Gas) welding method for TIG welding a high melting point member and a low melting point member, where melting points of the two members are different from each other, and a welded structure made by the method.

2. Description of the Related Art

In a general TIG welding method, two members are overlapped with each other and a welding arc is generated with a TIG welding torch facing and being adjacent to the overlapped portion of two members. The two members melt concurrently and mix with each other, then solidify to form a bead.

However, in the aforementioned conventional TIG welding method, differences between melting points of the two members to be welded causes non-conformity between melting degrees of the two members. Therefore, sufficient welding strength is not achieved. For example, in case that tough pitch copper whose melting point is relatively high is weld to copper-zinc alloy whose melting point is relatively low by means of the conventional TIG welding method, the copper-zinc alloy melts sufficiently but not the tough pitch copper. On the other hand, at a temperature where the tough pitch copper melts adequately, the tin included in the copper-zinc alloy sublimates to a gas, thus generating a number of blow holes. In either case, sufficient welding strength is not achieved by the conventional TIG welding method.

Notably, although “JIS (Japanese Industrial Standard) Industrial Term Dictionary” (published by Japanese Standards Association) describes the TIG welding method, there have been no bulletins or documents describing techniques for TIG welding two members whose melting points differ from each other.

### SUMMARY OF THE INVENTION

The present invention has been devised in consideration of the aforementioned circumstances, and aims to provide a TIG welding method and welded structure that are capable of enhancing, by comparison to the conventional method and structure, welding strength between members whose melting points differ from each other.

In order to achieve the above and other objects, the present invention provides a TIG welding method for welding a high melting point member and a low melting point member whose melting points are different from each other. In the method, a TIG welding torch is set more adjacent to the high melting point member than the low melting point member to generate an arc.

The present invention provides a welded structure by TIG welding a high melting point member and a low melting point member whose melting points are different from each other. In the structure, the high melting point member protrudes from a side surface or an end surface of the low melting point member, and the protrusion is melted to form a bead to cover the bonding portion between the high melting point member and the low melting point member. The bead can exhibit a volume of blow holes which is less than 5% of the bead volume.

### BRIEF DESCRIPTION OF THE DRAWINGS

Various other objects, features and many of the attendant advantages of the present invention will be readily appreciated as the same becomes better understood by reference to the following detailed description of the preferred embodiments when considered in connection with the accompanying drawing, in which:

FIG. 1 is an exploded view of parts composing a motor concerning to a first embodiment of the present invention.

FIG. 2 is a sectional side view of stator cores and a cylindrical housing of the motor.

FIG. 3 is a plan view of the cylindrical housing and bus bar holder.

FIG. 4(A) is a perspective view showing the state that bus bars are assembled.

FIG. 4(B) is a perspective view showing the state that bus bars are welded together.

FIG. 5 is a lateral view showing a TIG welding torch and bus bars.

FIG. 6 is a table indicating pictures of test pieces.

FIG. 7 is a table showing properties of tough pitch copper and copper-zinc alloy.

FIG. 8 is a table showing conditions of welding.

FIG. 9(A) is a perspective view showing an embodiment in which a wire is assembled to a bus bar.

FIG. 9(B) is a perspective view showing the state that the wire is welded to the bus bar.

FIG. 10 is a lateral view showing a TIG welding torch, a bus bar and a wire according to another embodiment.

### DESCRIPTION OF THE PREFERRED EMBODIMENTS

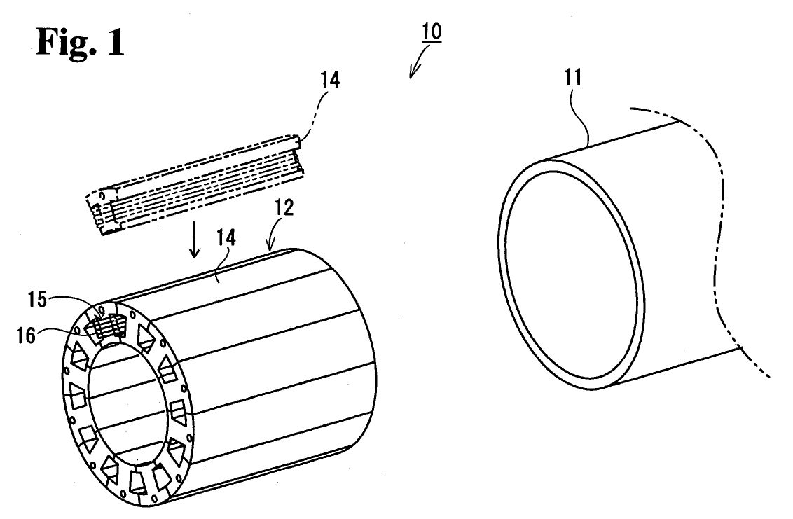

A preferred embodiment, which is applied to a connecting portion included in a motor, of the present invention will be described on the basis of FIG. 1 to FIG. 5. A motor 10 shown in FIG. 1 may be a brushless motor for an electric power steering system incorporated in an automobile, and has a stator core 12 in a cylindrical housing 11.

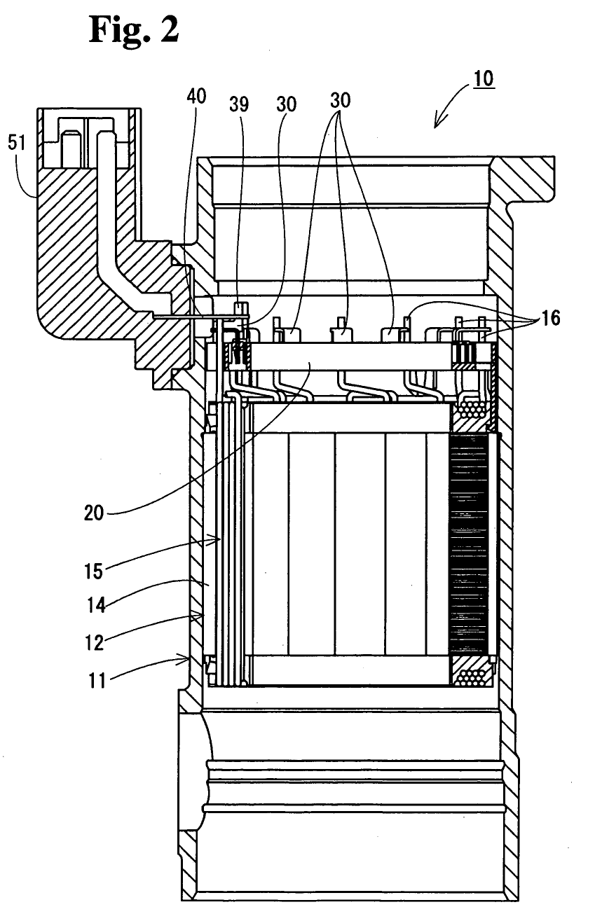

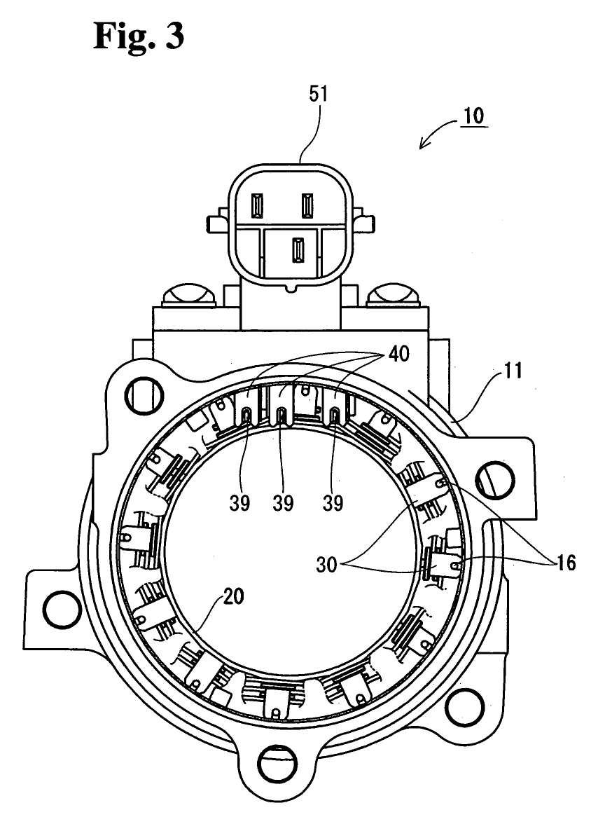

The stator core 12 has a structure dividable into a number of core bodies in the circumferential direction. A coil 15 is wounded around each core body 14 in the longitudinal direction (axial direction). Both ends of a wire 16 configuring the coil 15 are arranged at one end (upper end in FIG. 2) of the stator core 12 and penetrate a ring-shaped bus-bar holder 20. As shown in FIG. 3, a number of first bus bars 30 are held in the bus-bar holder 20 and are insulated from each other. Protrusions of each first bus bar 30 are directed toward the inner periphery of the cylindrical housing 11, and each of the protrusions is welded to one end portion of the associated wire 16. In addition, the wires 16 configuring the coils 15 are, at the other ends thereof, electrically connected to one another to construct a three-phase motor circuit.

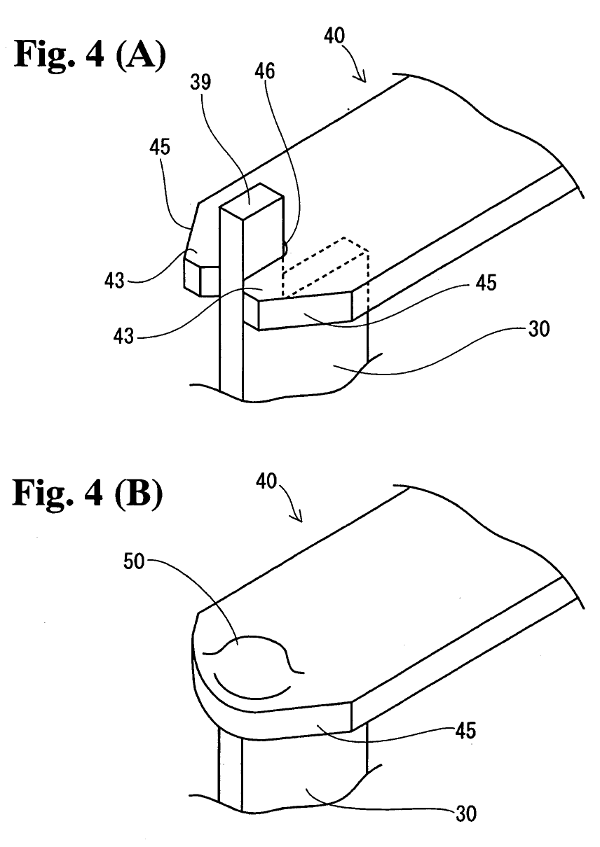

A tip end portion of each first bus bar 30 protrudes upward from the bus-bar holder 20 in FIG. 2, for forming tongue pieces 39. Further, as shown in FIG. 3, a connector 51 is attached to a peripheral surface of the cylindrical housing 11 and accommodates three second bus bars 40 by way of insert forming. A tip end portion of each second bus bar 40 protrudes inward from an inner peripheral surface of the cylindrical housing 11 and is welded to the tip end portion (tongue piece 39) of a first bus bar 30 protruding from the bus-bar holder 20 (with reference to FIG. 4(B)).

In the present embodiment, the first bus bars 30 are made of tough pitch copper as the “high melting point member” of the present invention. On the other hand, the second bus bars 40 are made of copper-zinc alloy as the “low melting point member” of the present invention. Notably, “high melting point” and “low melting point” indicate a relative relationship between the melting points of the two members. When there are two members whose melting points differ from each other, the member having a relatively high melting point is designated as “high melting point,” and member having a relatively low melting point is designated as “low melting point.”

The present embodiment embodies the invention in a welding portion between the first bus bars 30 and the second bus bars 40. Specifically, FIG. 4(A) shows the state before the first bus bar 30 and the second bus bar 40 are welded together. As shown in this Figure, the second bus bar 40 is formed with a slit 46 breaching the tip end portion thereof. The width of the slit 46 is approximately the same as the thickness of the first bus bar 30. The depth of the slit 46 is approximately the same as the width of the tongue piece 39 of the first bus bar 30.

As shown in FIG. 4(A), protrusions 43 formed at both sides of the slit 46 of the second bus bar 40 are linear-symmetric about the slit 46. At an outer edge of each protrusion 43 is formed a tapered surface 45 which tapers toward the slit 46 as it approaches the tip end thereof. The tongue piece 39 of the first bus bar 30 is inserted into the bottom of the slit 46 and protrudes from the upper surface of the second bus bar 40. The length of the protrusion is approximately one to three times of the thickness of the second bus bar 40.

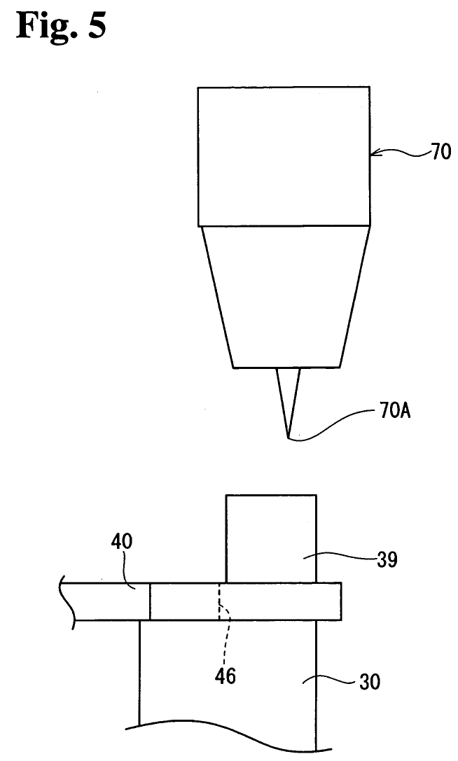

The first bus bar 30 and the second bus bar 40, configured as described above, are welded together by way of TIG welding. Specifically, as shown in FIG. 5, a tip end portion 70A of a TIG welding torch 70 is positioned adjacent to the tongue piece 39 of the first bus bar 30, then an arc is generated. Therefore, the first bus bar 30 (the high melting potion member) which is adjacent to the TIG welding torch 70 receives much more heat in comparison with the second bus bar 40 (the low melting point member). Accordingly, the first bus bar 30 and the second bus bar 40 melt properly. In addition, since protrusions 43 of the second bus bar 40 are formed into a tapered shape, the tip end sides of the protrusions 43 are melted surely. Then, the material of the first bus bar 30 and the second bus bar 40 are mixed in the melted state. When the melted metal solidifies, a bead 50 is formed at a crossing portion between the first bus bar 30 and the second bus bar 40 as shown in FIG. 4(B), thus integrally connecting the first bus bar 30 and the second bus bar 40.

Since the wire 16 is made of tough pitch copper which may be the same as the first bus bar 30, the wire 16 and the first bus bar 30 are welded together by way of conventional welding, i.e. welding between members having the same melting point, to connect them integrally.

According to the TIG welding method and welded structure of the embodiment described above, the TIG welding torch 70 is positioned closer to the first bus bar 30 than the second bus bar 40, then an arc is generated. Thus, the second bus bar 40 as the low melting point member is prevented from being overheated, generation of blow holes is suppressed, insufficient melting of the first bus bar 30 as the high melting point member is diminished, and welding strength is improved in comparison with the conventional method and structure. According to the TIG welding method and the welded structure of this embodiment, it is possible to weld two metal members whose melting points differ each other, in the electrical equipment such as aforementioned motor 10, which is applied to a vehicle and suffers from vibrations and changes of temperature.

### EXAMPLES

The following experiment was executed in order to confirm the effects of the embodiment of the invention.

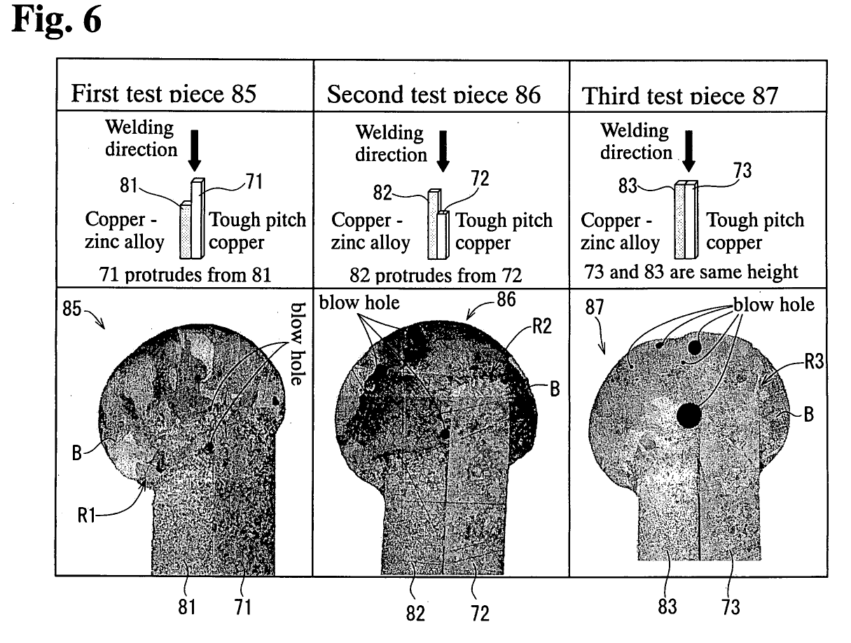

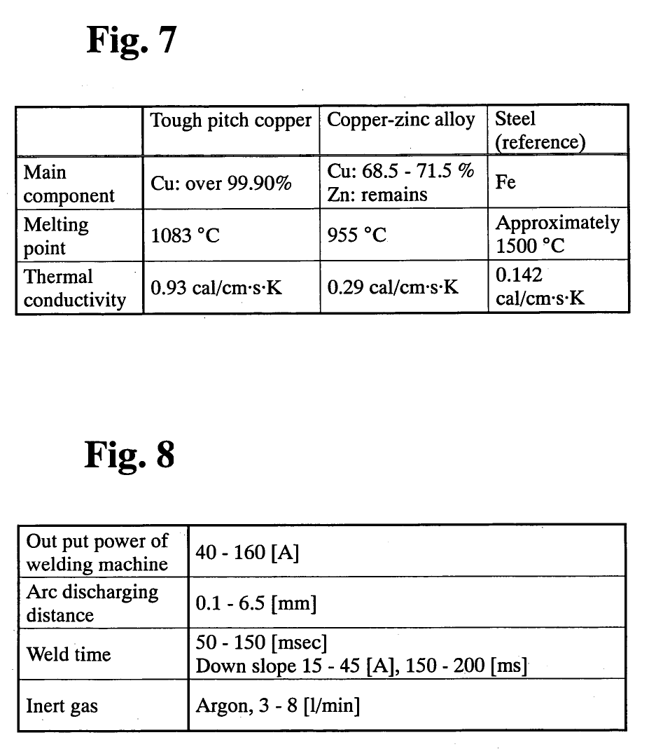

1) Rectangular-rod-shape high melting point members 71, 72 and 73 made of tough pitch copper whose properties are shown in FIG. 7 were provided (referring to FIG. 6).

2) Rectangular-rod-shape low melting point members 81, 82 and 83 made of copper-zinc alloy whose properties are shown in FIG. 7 were provided (referring to FIG. 6).

3) As shown in the left column of FIG. 6, the high melting point member 71 and the low melting point member 81 were in contact with each other at the respective side walls and were held such that the high melting point member 71 protruded upward from the top surface of the low melting point member 81. An arc was generated at only the area of clearance between the TIG welding torch and the high melting point member 71. Thus, the melted high melting point member 71 adhered to the low melting point member 81 located therebelow to form a first test piece 85.

4) As shown in the center column of FIG. 6, the high melting point member 72 and the low melting point member 82 were in contact with each other at the respective side walls and were held such that the low melting point member 82 protruded upward from the top surface of the high melting point member 72. An arc was generated at only the area of clearance between the TIG welding torch and the low melting point member 82. Thus, the melted low melting point member 82 adhered to the high melting point member 72 located therebelow to form a second test piece 86.

5) As shown in the right column of FIG. 6, the high melting point member 73 and the low melting point member 83 were in contact with each other at the respective side walls and were held such that both top surfaces of the high. melting point member 73 and the low melting point member 83 were approximately aligned. The TIG welding torch was positioned adjacent the contact surface between the top surfaces of the high melting point member 73 and the low melting point member 83, and then an arc was generated to form a third test piece 87.

6) The test pieces 85-87 were cut and respective cut surfaces of the test pieces were subjected to etching treatment. Each welded portion of the test piece was examined using a metaloscope to weigh blow holes and the degree of mixing of the high melting point member and the low melting point member. Pictures, which were photographed by the metaloscope, of the cut surfaces of the test pieces 85-87 are shown at the bottom of FIG. 6. At steps 3), 4) and 5), each TIG welding was performed under the same conditions, as shown in FIG. 8.

In comparing the test pieces 85-87, it was found that blow holes occupied less volume in the first test piece 85 subjected to the TIG welding method of the embodiment than that in the second or third test pieces 86 or 87 subjected to the another TIG welding method. Specifically, the first test piece 85 indicated less than an approximately 1% volume presence of blow holes, the second test piece 86 indicated an approximately 5% volume presence of blow holes and the third test piece 87 indicated an approximately 5% volume presence of blow holes.

Concerning the second test piece 86, a boundary R2 between a bead B and the high melting point member 72 was clearly shown. On the other hand, concerning the first test piece 85 employing the TIG welding method of the embodiment, a boundary R1 between a bead B and the low melting point member 81 was diffused. Further, when pictures were colored, it was found that a boundary R3 between a bead B and the high melting point member 73 was clear with respect to the third test piece 87. This indicates that the high melting point member 71 and low melting point member 81 were mixed to a greater degree in the first test piece 85 subjected to the method of the embodiment in comparison to the second and the third test pieces 86 and 87.

Other Embodiments

The present invention is not limited to the aforementioned embodiment. For example, modifications described below are included in the scope to be protected by the invention.

(1) In the aforementioned embodiment, the present invention is exemplified by application to the connecting portion within a motor. However, the invention can be applicable to a connecting portion between members that are provided in various electrical equipment other than motors.

(2) In the embodiment, the present invention is exemplified by applying the welding to tough pitch copper and copper-zinc alloy. However, the invention can be applicable to welding between members of other kinds of copper alloys, and is also applicable to the welding between members of iron alloys or between members of aluminum alloys. Further, the invention can be applicable to the welding, for example, between a member of copper alloy and a member of aluminum alloy, i.e. welding between different kinds of alloys whose base metals are different from each other.

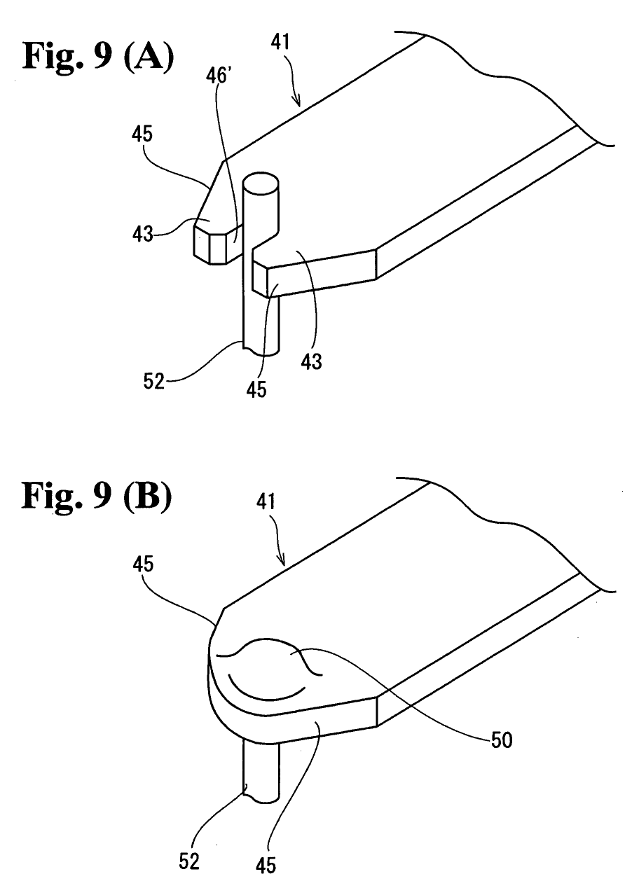

(3) In the embodiment, the invention is embodied in the welding between the bus bars 30 and 40. However, as shown in FIG. 9(A) and FIG. 9(B), a present invention can be applied to a portion of welding between the bus bar 41 and a wire 52. The wire 52 is disposed in a slit 46′ whose tip end structure is approximately the same as that of the second bus bar 40 of the aforementioned embodiment of the bus bar 41, with the wire protruding from the top surface of the bus bar 41. In such a state, the TIG welding torch is set adjacent to the tip end of the wire 52 to generate an arc (referring to FIG. 9(B)).

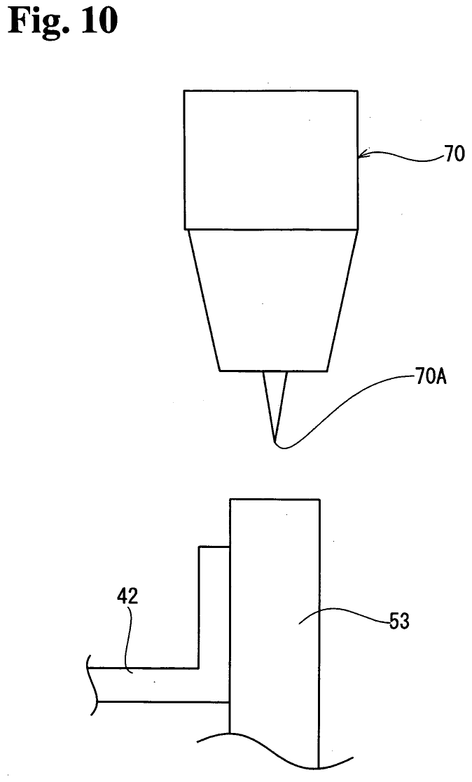

(4) The present invention can be also embodied in welding as shown in FIG. 10, for example. Specifically, a tip end of a bus bar 42 extending in the horizontal direction is upwardly bent by a right angle. A wire 53 is brought into contact with the bus bar 42 at the bent tip end thereof to upwardly protrude from the tip end. In such a state, the TIG welding torch is set adjacent to a tip end of the wire 53 to generate an arc.

The embodiments described herein are to be regarded as illustrative rather than restrictive. Plural objectives are achieved by the present invention, and yet there is usefulness in the present invention as far as one of the objectives is achieved. Variations and changes may be made by others, and equivalents employed, without departing from spirit of the present invention. Accordingly, it is expressly intended that all variations, changes and equivalents which fall within the spirit and scope of the present invention as defined in the claims, be embraced thereby.

1. A TIG welding method for welding a high melting point member and a low melting point member whose melting points are different from each other, comprising the steps of:
arranging a high melting point member and a low melting point member such that a portion of the high melting point member protrudes relative to the low melting point member;
setting a TIG welding torch to a position closer to the protruding portion of the high melting point member than the low melting point member; and
generating an arc between the TIG welding torch at said position and at least the protruding portion of the high melting point member.

2. A TIG welding method according to claim 1, wherein the high melting point member and the low melting point member are mainly composed of the same metal.

3. A TIG welding method according to claim 2, wherein both of the high melting point member and the low melting point member are mainly composed of iron.

4. A TIG welding method according to claim 2, wherein both of the high melting point member and the low melting point member are mainly composed of aluminum.

5. A TIG welding method according to claim 2, wherein both of the high melting point member and the low melting point member are mainly composed of copper.

6. A TIG welding method according to claim 5, wherein the high melting point member is made of tough pitch copper and the low melting point member is made of copper-zinc alloy.

7. A TIG welding method according to claim 1, wherein the low melting point member is a bus bar having a slit splitting a tip end thereof, and a tip end of the high melting point member is inserted into the slit.

8. A welded structure made by TIG welding a high melting point member and a low melting point member whose melting point are different from each other, comprising a weld bead formed from a melt of the high melting point member and the low melting point member, wherein a volume of blow holes in the weld bead is less than 5%.

9. A welded structure by TIG welding according to claim 8, wherein the high melting point member and the low melting point member are provided in an electrical equipment for a vehicle.

10. A welded structure by TIG welding according to claim 9, wherein the electrical equipment is a motor applied to a power steering apparatus, and the high melting point member and the low melting point member are bus bars welded together.

11. A welded structure by TIG welding according to claim 10 wherein,
the low melting point member is a bus bar having a slit splitting a tip end thereof,
a tip end the of the high melting point member is inserted into the slit to protrude from a side surface of the bus bar, then melted to form the bead.

12. A TIG welding method for welding a high melting point member and a low melting point member whose melting points are different from each other, wherein the high melting point member protrudes from the low melting point member, and TIG welding torch is directed to the high melting point member to generate an arc.

13. A TIG welding method for welding a high melting point member and a low melting point member whose melting points are different from each other, the method comprising:
a step of forming a slit on the low melting point member;
a step of inserting the high melting point member into the slit to protrude from the slit;
a step of approaching a TIG welding torch to a position closer to the high melting point member than the low melting point member; and
a step of generating an arc with the TIG welding torch at said position.

14. A welded structure by TIG welding according to claim 8, wherein the volume of blow holes in the bead is less than 1%.
